(19) United States
(12) Patent Application Publication
(10) Pub. No.: US 2010/0234160 A1
(43) Pub. Date: Sep. 16, 2010

(54) DIFFERENTIAL GEAR DEVICE

(75) Inventors: Shinichiro Ishikawa, Toyota-shi (JP); Masato Kurosaki, Toyota-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/698,552

(22) Filed: Feb. 2, 2010

(30) Foreign Application Priority Data
Mar. 11, 2009 (JP) JP2009-057928

(51) Int. Cl. F16H 57/04; F16H 48/06

(52) U.S. Cl. 475/161; 475/230

(57) ABSTRACT

A differential gear device includes a case that rotates around a rotation center line; a first protruding portion protruding from an inner surface of the case toward the rotation center line; a rotatable first gear provided around the first protruding portion; and a second gear including a ring-shaped base portion, and a connection portion formed on an inner peripheral surface of the base portion, and connected to an output shaft, wherein the second gear engages with the first gear. One end of the base portion, which is located in the case at a position inside an opposite end of the base portion in an axial direction of the output shaft, is located in a region that is located directly ahead of the first protruding portion in a direction in which the first protruding portion protrudes.

### INCORPORATION BY REFERENCE

The disclosure of Japanese Patent Application No. 2009-057928 filed on Mar. 11, 2009 including the specification, drawings and abstract is incorporated herein by reference in its entirety.

### BACKGROUND OF THE INVENTION

1. Field of the Invention

The invention relates to a differential gear device, and more specifically, a differential gear device with reduced size.

2. Description of the Related Art

Differential gear devices installed in vehicles have been proposed. For example, Japanese Patent Application Publication No. 2008-275042 (JP-A-2008-275042) describes a differential gear device that includes a differential case. The differential case includes holding portions that hold pinion gears; and open windows used when gears are mounted. The holding portions are formed in the differential case at two positions. In each of the holding portions, the pinion gear is provided. Side gears engage with the pinion gears.

Japanese Patent Application Publication No. 2008-14419 (JP-A-2008-14419) describes a differential device that includes a differential mechanism; and a differential control device that controls a differential action of the differential mechanism. The differential mechanism includes a differential case; pinion shafts inserted into through holes formed in the differential case; pinion gears supported by the pinion shafts; and side gears that engage with the pinion gears. The pinion shafts extend through the differential case.

Japanese Patent Application Publication No. 2002-364730 (JP-A-2002-364730) describes a differential device that includes a bevel gear differential mechanism. The differential mechanism includes pinion shafts connected to a differential case via intermediate members; pinion gears provided on the pinion shafts; and output-side side gears that engage with the pinion gears.

Japanese Patent Application Publication No. 9-184561 (JP-A-9-184561) describes a differential device that includes a differential case; differential pinion shafts provided in the differential case; and differential pinion gears provided on the differential pinion shafts. The pinion gears are provided on the differential pinion shafts, and side gears engage with the pinion shafts.

In the differential gear device described in the publication No. 2008-275042, one of the side gears is disposed on one side of a region located between the pinion gears, and the other of the side gears is disposed on the other side of the region. Thus, the side gears are disposed away from each other. Therefore, the region located between the pinion gears and between the side gears is a dead space. As a result, the size of the differential gear device is increased.

In the differential gear device described in the publication No. 2008-14419, the pinion shafts extend through the differential case. One of the side gears is disposed on one side of the pinion shafts, and the other of the side gears is disposed on the other side of the pinion shafts. Thus, the side gears are disposed away from each other. As a result, a distance between the side gears is increased, and the size of the differential device is increased.

In the differential device described in the publication No. 2002-364730, the side gears are disposed away from each other. A region, which is located directly ahead of the pinion shaft in a direction in which the pinion shaft protrudes, is a dead space.

In the differential device described in the publication No. 9-184561 as well, the side gears are disposed away from each other so that there is a large distance between the side gears. A region between the side gears is a dead space.

### SUMMARY OF THE INVENTION

The invention provides a differential gear device with reduced size.

An aspect of the invention relates to a differential gear device that includes a case in which a housing portion is formed, and which rotates around a rotation center line; a first protruding portion that is located at a position away from the rotation center line, and protrudes from an inner surface of the case toward the rotation center line; a first gear that is provided around the first protruding portion, and that is rotatable; a second gear including a first base portion that has a ring shape, and a first connection portion that is formed on an inner peripheral surface of the first base portion, and that is connected to a first output shaft, wherein the second gear engages with the first gear; and a third gear including a second base portion that has a ring shape, and a second connection portion that is formed on an inner peripheral surface of the second base portion, and that is connected to a second output shaft, wherein the third gear engages with the first gear. One end of the first base portion, which is located in the case at a position more inward than an opposite end of the first base portion in a direction of an axis of the first output shaft, is located in a region that is located directly ahead of the first protruding portion in a direction in which the first protruding portion protrudes.

The differential gear device according to the aspect may further include a cooling medium supply portion through which a cooling medium is supplied into the case. The first base portion may include a first increasing-diameter portion located closer to the inner surface of the case than the first connection portion is; a diameter of an inner peripheral surface of the first increasing-diameter portion may increase in a direction from the first connection portion toward the inner surface of the case; and a first cooling medium receiving portion that receives the cooling medium may be formed by the inner peripheral surface of the first increasing-diameter portion, an outer peripheral surface of the first output shaft, and the inner surface of the case.

A thickness of the first increasing-diameter portion in a direction perpendicular to a hypothetical center plane positioned at a center between the inner peripheral surface of the first increasing-diameter portion and an outer peripheral surface of the first increasing-diameter portion may be constant from one end of the first increasing-diameter portion, which is located closer to the first connection portion than an opposite end of the first increasing-diameter portion is, to the opposite end of the first increasing-diameter portion, which is located closer to the inner surface of the case than the one end of the first increasing-diameter portion is.

One end of the second connection portion, which is located in the case at a position more outward than an opposite end of the second connection portion in a direction of an axis of the second output shaft, may be located more inward than one end of the second base portion in the direction of the axis of the second output shaft, the one end of the second base portion being located in the case at a position more outward than an opposite end of the second base portion in the direction of the axis of the second output shaft.

The differential gear device according to the aspect may further include a cooling medium supply portion through which a cooling medium is supplied into the case. The second base portion may include a second increasing-diameter portion located closer to the inner surface of the case than the second connection portion is; a diameter of an inner peripheral surface of the second increasing-diameter portion may increase in a direction from the second connection portion toward the inner surface of the case; and a second cooling medium receiving portion that receives the cooling medium may be formed by the inner peripheral surface of the second increasing-diameter portion, an outer peripheral surface of the second output shaft, and the inner surface of the case.

A thickness of the second increasing-diameter portion in a direction perpendicular to a hypothetical center plane positioned at a center between the inner peripheral surface of the second increasing-diameter portion and an outer peripheral surface of the second increasing-diameter portion may be constant from one end of the second increasing-diameter portion, which is located closer to the second connection portion than an opposite end of the second increasing-diameter portion is, to the opposite end of the second increasing-diameter portion, which is located closer to the inner surface of the case than the one end of the second increasing-diameter portion is.

The case may include a first shaft support portion that supports the first output shaft; and at least a portion of the first shaft support portion may project from the inner surface of the case toward the first increasing-diameter portion.

The case may include a second shaft support portion that supports the second output shaft; and at least a portion of the second shaft support portion may project from the inner surface of the case toward the second increasing-diameter portion.

The differential gear device according to the aspect of the invention has reduced size.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a sectional view of a differential gear device according to an embodiment of the invention;

FIG. 2 is a sectional view showing in detail a side gear and a configuration around the side gear in the embodiment of the invention;

FIG. 3 is a sectional view showing a side gear and a configuration near the side gear in the embodiment of the invention;

FIG. 4 is a sectional view showing a modified example of a protruding portion in the embodiment of the invention; and

FIG. 5 is a sectional view showing a modified example of the protruding portion in the embodiment of the invention.

### DETAILED DESCRIPTION OF EMBODIMENTS

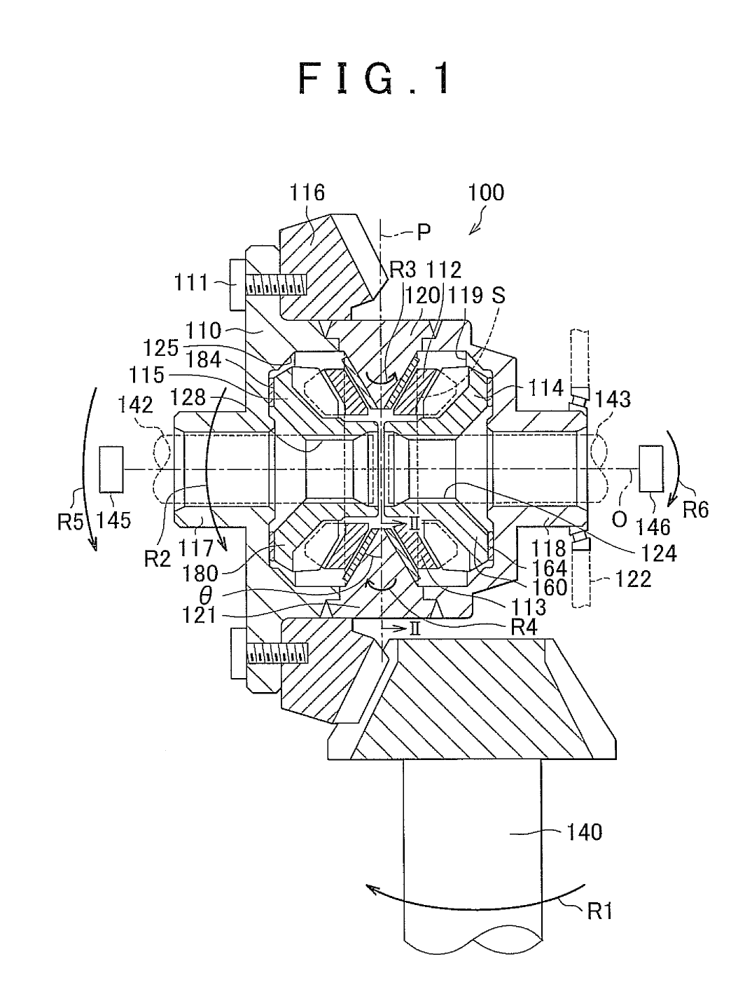

A differential gear device 100 according to an embodiment of the invention will be described with reference to FIG. 1 to FIG. 5. When reference is made to number of components, amounts, and the like in the embodiment described below, the invention is not necessarily limited to the numbers of components, the amounts, and the like, unless otherwise specified. Also, in the embodiment described below, each constituent element is not necessarily indispensable for the invention, unless otherwise specified. When a plurality of embodiment are described below, it has been assumed that features of the embodiments may be appropriately combined, unless otherwise specified.

As shown in FIG. 1, the differential gear device 100 includes a differential case 110; protruding portions 120 and 121 provided in the differential case 110; and pinion gears 112 and 113 rotatably provided around peripheral surfaces of the respective protruding portions 120 and 121.

A hollow is formed in the differential case 110, and the hollow in the differential case 110 serves as a housing portion 125. The differential case 110 is installed in a vehicle so that the differential case 110 is rotatable around a rotation center line O. Drive shaft support portions 117 and 118 are formed in the differential case 110. Each of the drive shaft support portions 117 and 118 is cylindrical, and extends in the direction of the rotation center line O.

A circular flange portion is formed on an outer peripheral surface of the differential case 110. A ring gear 116 is fixed to the flange portion by bolts 111. The ring gear 116 engages with a drive pinion gear 140 that is rotated by power from, for example, an engine. A propeller shaft (not shown) is connected to the drive pinion gear 140.

Therefore, when the drive pinion gear 140 rotates in a rotation direction R1, the differential case 110 rotates in a rotation direction R2 around the rotation center line O.

The protruding portions 120 and 121 are located at positions away from the rotation center line O, and protrude from an inner surface of the differential case 110. Accordingly, when the differential case 110 rotates around the rotation center line O, the protruding portions 120 and 121 revolve around the rotation center line O. Each of the protruding portions 120 and 121 tapers in a direction away from the inner surface of the differential case 110. More specifically, each of the protruding portions 120 and 121 tapers in the direction from the inner surface of the differential case 110 toward the rotation center line O. Therefore, a center line of the protruding portions 120 and 121 is orthogonal to the rotation center line O. The protruding portions 120 and 121 are away from each other. The protruding portion 121 is on the opposite side of the rotation center line O from the protruding portion 120, and the protruding portions 120 and 121 face each other.

The pinion gears 112 and 113 are placed around peripheral surfaces of the respective protruding portions 120 and 121 so that the pinion gears 112 and 113 are rotatable around the rotation center line P orthogonal to the rotation center line O.

In the housing portion 125, side gears 114 and 115 are provided. The side gear 114 engages with the pinion gears 112 and 113. The side gear 114 is spline-connected to a drive shaft 143. The side gear 115 engages with the pinion gears 112 and 113. The side gear 115 is spline-connected to a drive shaft 142. The drive shaft 143 is connected to a wheel 146, and the drive shaft 142 is connected to a wheel 145. Both of the drive shafts 142 and 143 extend in the direction of the rotation center line O. The drive shaft 143 is inserted in the drive shaft support portion 118, and the drive shaft 142 is inserted in the drive shaft support portion 117.

The side gear 114 includes a base portion 160, and a plurality of teeth formed on an outer peripheral surface of the base portion 160. The base portion 160 is cylindrical. The drive shaft 143 is inserted in the base portion 160. A spline portion 124 is formed on an inner peripheral surface of the base portion 160. The drive shaft 143 is spline-connected to the spline portion 124.

In the differential case 110, an end of the spline portion 124, which is closer to the inner surface of the differential case 110 than an opposite end of the spline portion 124 is, is located inside an end of the base portion 160, which is closer to the inner surface of the differential case 110 than an opposite end of the base portion 160 is.

The protruding portion 120 protrudes from the inner surface of the differential case 110 in a direction of the rotation center line P. The base portion 160 extends into a region S located directly ahead of the protruding portion 120 in a direction in which the protruding portion 120 protrudes. The region S is a region that is in the shadow of a portion of the protruding portion 120, which protrudes from the inner surface of the differential case 110, when light is emitted from the outside of the differential case 110 toward the protruding portion 120 in the direction of the rotation center line P (i.e., the center line of the protruding portion 120). The region S is located between the protruding portions 120 and 121. The base portion 160 is disposed so that a projection plane on which the protruding portions 120 and 121 are projected in the direction of the rotation center line P overlaps a projection plane on which the base portion 160 is projected in the direction of the rotation center line P.

Thus, the side gear 114 is disposed so that the end of the base portion 160 of the side gear 114, which is farther from the differential case 110 than the opposite end of the base portion 160 is in the direction of the rotation center line O, is located in the region S. Therefore, the entire side gear 114 is disposed close to the rotation center line P. Thus, the size of the differential case 110 and the size of the differential gear device 100 are reduced.

The side gears 114 and 115 are disposed away from each other in the direction of the rotation center line O. The rotation center line P extends between the side gears 114 and 115. The side gear 115 is formed in the same manner as the manner in which the side gear 114 is formed. More specifically, the side gear 115 is cylindrical. The side gear 115 includes a base portion 180 in which the drive shaft 142 is inserted, and a plurality of teeth formed on an outer peripheral surface of the base portion 180.

An end of the base portion 180, which is closer to the rotation center line P than an opposite end of the base portion 180 is, is located in the region S. Thus, the entire side gear 115 is also disposed close to the rotation center line P. Accordingly, an end surface of the side gear 115, which is farther from the differential case 110 than an opposite end surface of the side gear 115 is in the direction of the rotation center line O, is disposed close to the rotation center line P. Thus, the size of the housing portion 125 is reduced. Accordingly, the size of the differential case 110 and the size of the differential gear device 100 are reduced.

Thus, by forming both of the side gears 114 and 115 so that both of the side gears 114 and 115 extend into the region S, the size of the differential gear device 100 is further reduced.

Both of the side gears 114 and 115 are positioned in the direction of the rotation center line O by the pinion gears 112 and 113, and washers provided between the side gears 114 and 115 and the differential case 110. Thus, the side gears 114 and 115 are prevented from contacting each other.

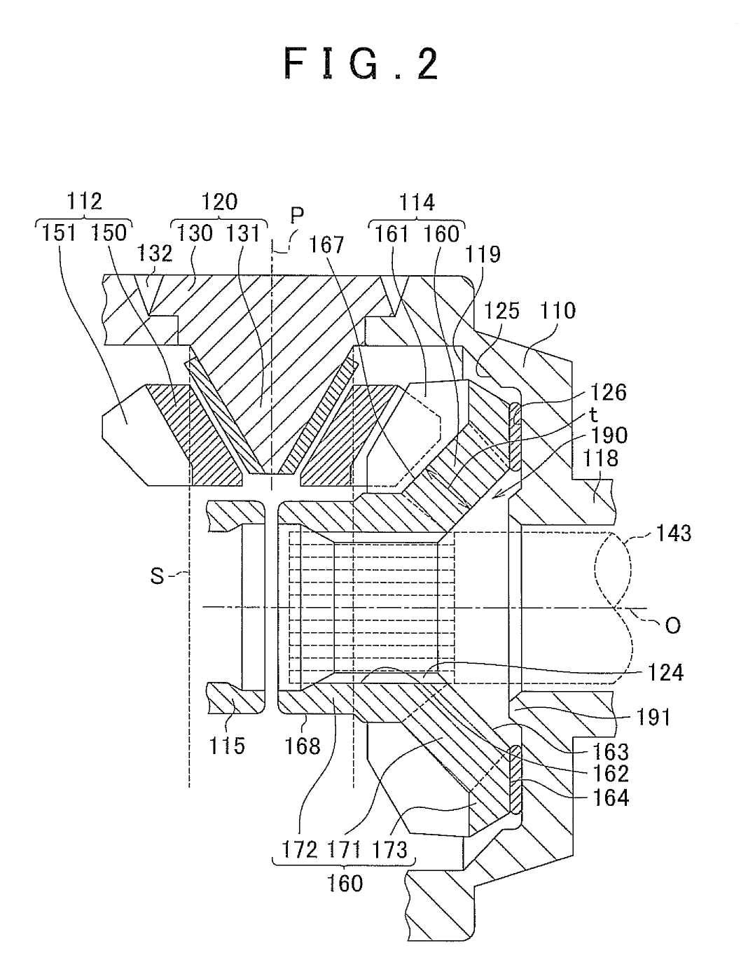

As shown in FIG. 2, a plurality of teeth 161 are formed on an outer peripheral surface of the base portion 160 at intervals in a circumferential direction of the base portion 160.

The base portion 160 includes an increasing-diameter portion 171; a cylindrical extension portion 172 that is continuous with the increasing-diameter portion 171; and a flange portion 173 that is continuous with the increasing-diameter portion 171, and that is located on the opposite side of the increasing-diameter portion 171 from the extension portion 172.

An inner peripheral surface of the increasing-diameter portion 171 is a truncated cone surface 163 that has the same shape as that of a tapered surface of a truncated cone. That is, the diameter of the truncated cone surface 163 increases in a direction from the region S toward the inner surface of the differential case 110.

An oil receiving portion 190 is formed by the inner surface of the differential case 110, the truncated cone surface 163, and an outer peripheral surface of the drive shaft 143. The oil receiving portion 190 receives oil such as lubricating oil and cooling oil. The oil receiving portion 190 has a ring shape, and surrounds the peripheral surface of the drive shaft 143. Because the oil, such as the lubricating oil and the cooling oil, is retained in the oil receiving portion 190, the cooling of the side gear 114 and the like is promoted.

A gear insertion hole 119 is formed in the differential case 110. The gear insertion hole 119 is used to insert the pinion gears 112 and 113 and the side gears 114 and 115 in the differential case 110 when the differential gear device 100 is assembled.

The differential gear device 100 is housed in a differential carrier (i.e., a housing) 122 shown in FIG. 1. The oil (i.e., a cooling medium) is retained in the differential carrier 122. Therefore, the oil enters the differential case 110 through the gear insertion hole 119 (i.e., a cooling medium supply portion). Thus, a portion of the oil that has entered the differential case 110 is retained in the oil receiving portion 190.

The flange portion 173 extends from a large-diameter end of the increasing-diameter portion 171 in a direction perpendicular to the rotation center line O, in other words, in a direction away from the rotation center line O. An end surface 164 of the flange portion 173, which is located closer to the differential case 110 than an opposite end surface of the flange portion 173 is in the direction of the rotation center line O, is a flat surface perpendicular to the rotation center line O. An inside surface 126 is a portion of the inner surface of the differential case 110 that defines the housing portion 125, and the inside surface 126 faces the end surface 164. The inside surface 126 is also perpendicular to the rotation center line O. The ring-shaped washer is disposed between the inside surface 126 and the end surface 164.

The extension portion 172 is cylindrical. The extension portion 172 extends in the direction of the rotation center line O, from the end of the increasing-diameter portion 171, which is opposite to the end of the increasing-diameter portion 171 that is adjacent to the flange portion 173. An end portion of the drive shaft 143 is inserted in the extension portion 172 and the increasing-diameter portion 171.

A spline portion is formed on the end portion of the drive shaft 143. The spline portion of the drive shaft 143 is spline-connected to the spline portion 124 formed on an inner peripheral surface 162 of the extension portion 172.

The extension portion 172 extends from the increasing-diameter portion 171 to a position close to the rotation center line P. An end of the extension portion 172 is located in the region S located directly ahead of the protruding portion 120 in the direction in which the protruding portion 120 protrudes.

The teeth 161 are formed on an outer peripheral surface 167 of the increasing-diameter portion 171 and the flange portion 173, and a portion of an outer peripheral surface 168 of the extension portion 172, which is located close to the increasing-diameter portion 171. The extension portion 172 extends to a position between the teeth 161 and the rotation center line P, and extends into the region S located directly ahead of the protruding portion 120 in the direction in which the protruding portion 120 protrudes.

Therefore, the size of the differential case 110 is reduced, as compared to a differential case in which a portion of the side gear, which supports the drive shaft 143, extends from the teeth 161 toward the inner surface of the differential case 110.

A thickness t of the increasing-diameter portion 171 (i.e., a distance perpendicular to a hypothetical center plane positioned at a center between the outer peripheral surface 167 and the truncated cone surface 163) is constant from the end of the increasing-diameter portion 171, which is adjacent to the flange portion 173, to the end of the increasing-diameter portion 171, which is adjacent to the extension portion 172.

Therefore, even if the temperature of the side gear 114 becomes high due to friction heat and the like, it is possible to reduce the possibility that a portion of the increasing-diameter portion 171 is deformed to a large extent.

The drive shaft support portion 118 extends through the inside surface 126. An end of the drive shaft support portion 118, which is opened toward an inside of the differential case 110, faces an end of the truncated cone surface 163. The drive shaft support portion 118 extends in the direction of the rotation center line O.

When the drive shaft 143 inserted in the drive shaft support portion 118 bows, the drive shaft support portion 118 supports the drive shaft 143 to reduce bowing of the drive shaft 143.

At least a portion of the drive shaft support portion 118 projects from the inside surface 126 toward the increasing-diameter portion 171. More specifically, a projection portion 191, which defines the end of the drive shaft support portion 118, is formed on the inside surface 126. The projection portion 191 has a ring shape, and protrudes from the inside surface 126 toward the increasing-diameter portion 171.

Because the drive shaft support portion 118 includes the projection portion 191 that projects from the inside surface 126, the length of a region of the drive shaft 143, which is supported by the drive shaft support portion 118, is increased. Thus, bowing of the drive shaft 143 is reduced. Further, because the projection portion 191 is formed on the inner surface of the differential case 110, an increase in the size of the differential case 110 is suppressed.

The protruding portion 120 includes a fitting portion 130 fitted to the differential case 110, and a tapered protrusion 131 that protrudes from the fitting portion 130 into the housing portion 125.

The tapered protrusion 131 has a cone shape or a truncated cone shape. The pinion gear 112 is placed around the tapered protrusion 131. The pinion gear 112 has a ring shape. The pinion gear 112 includes a base portion 150 in which a through hole is formed; and a plurality of teeth 151 formed on an outer peripheral surface of the base portion 150.

Thus, by forming the tapered protrusion 131 so that the tapered protrusion 131 has a cone shape or a truncated cone shape, it is possible to increase frictional force generated between the pinion gear 112 and the tapered protrusion 131 when the pinion gear 112 revolves around the rotation center line O and centrifugal force is applied to the pinion gear 112. The frictional force generated between the pinion gear 112 and the tapered protrusion 131 functions as braking force. Thus, when one wheel is idling, it is possible to transmit power to the other wheel that is not idling.

Although the side gear 114 has been described with reference to FIG. 2, the side gear 115 is formed in the same manner as the manner in which the side gear 114 is formed.

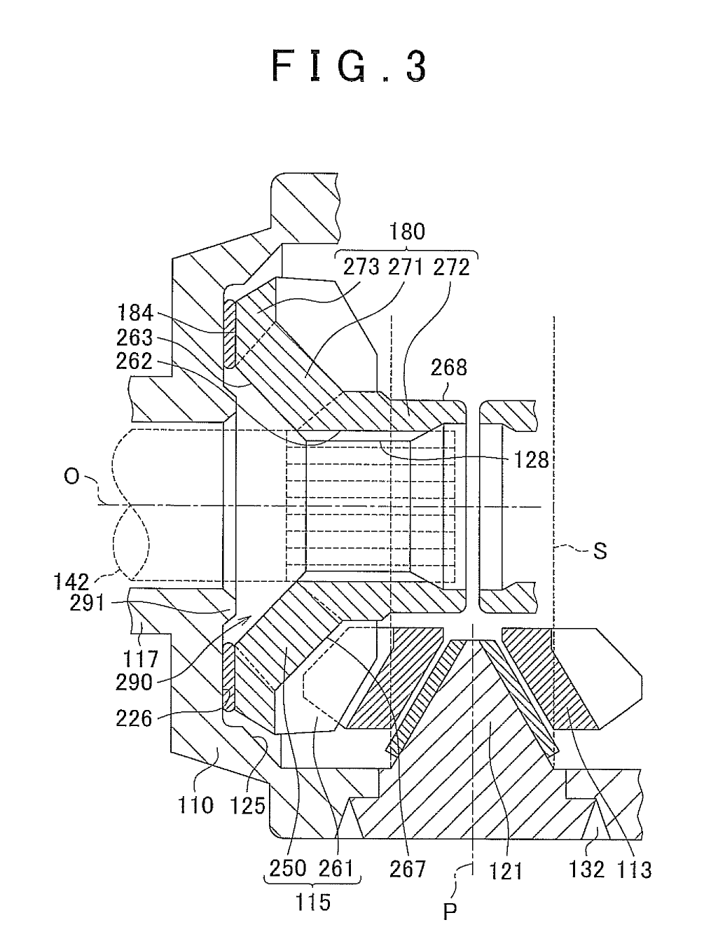

The side gear 115 shown in FIG. 3 includes a base portion 260; and a plurality of teeth 261 formed on an outer periphery of the base portion 260. The base portion 260 is cylindrical. The drive shaft 142 is inserted in the base portion 260.

The protruding portion 121 protrudes from the inner surface of the differential case 110 toward the rotation center line O. The base portion 260 extends into the region S located directly ahead of the protruding portion 121 in the direction in which the protruding portion 121 protrudes. Thus, the entire side gear 115 is located close to the rotation center line P. Therefore, the size of the differential case 110 and the size of the differential gear device 100 are reduced.

The base portion 260 includes an increasing-diameter portion 271; a cylindrical extension portion 272 that is continuous with the increasing-diameter portion 271; and a flange portion 273 that is continuous with the increasing-diameter portion 271, and that is located on the opposite side of the increasing-diameter portion 271 from the extension portion 272.

An inner peripheral surface of the increasing-diameter portion 271 is a truncated cone surface 263 that has the same shape as that of the tapered surface of the truncated cone. That is, the diameter of the truncated cone surface 263 increases in a direction from the region S toward an inside surface 226 of the differential case 110. The increasing-diameter portion 271 is widely opened toward the differential case 110. An oil receiving portion 290 is formed among the truncated cone surface 263, the inner surface of the differential case 110, and an outer peripheral surface of the drive shaft 142.

A spline portion is formed on an end portion of the drive shaft 142. The spline portion is connected to a spline portion 128 formed on an inner peripheral surface 262 of the extension portion 272.

An end of the extension portion 272 is located in the region S located directly ahead of the protruding portion 121 in the direction in which the protruding portion 121 protrudes. The teeth 261 are formed on an outer peripheral surface 267 of the increasing-diameter portion 271 and the flange portion 273, and a portion of an outer peripheral surface 268 of the extension portion 272, which is located close to the increasing-diameter portion 271. The thickness of the increasing-diameter portion 271 is substantially uniform.

At least a portion of the drive shaft support portion 117 projects from the inside surface 226 toward the increasing-diameter portion 271. More specifically, a projection portion 291 that defines an end of the drive shaft support portion 117 is formed on the inner surface of the differential case 110. The projection portion 291 projects from the inner surface of the differential case 110 toward the increasing-diameter portion 271. Thus, the amount of bowing of the drive shaft 142 is reduced.

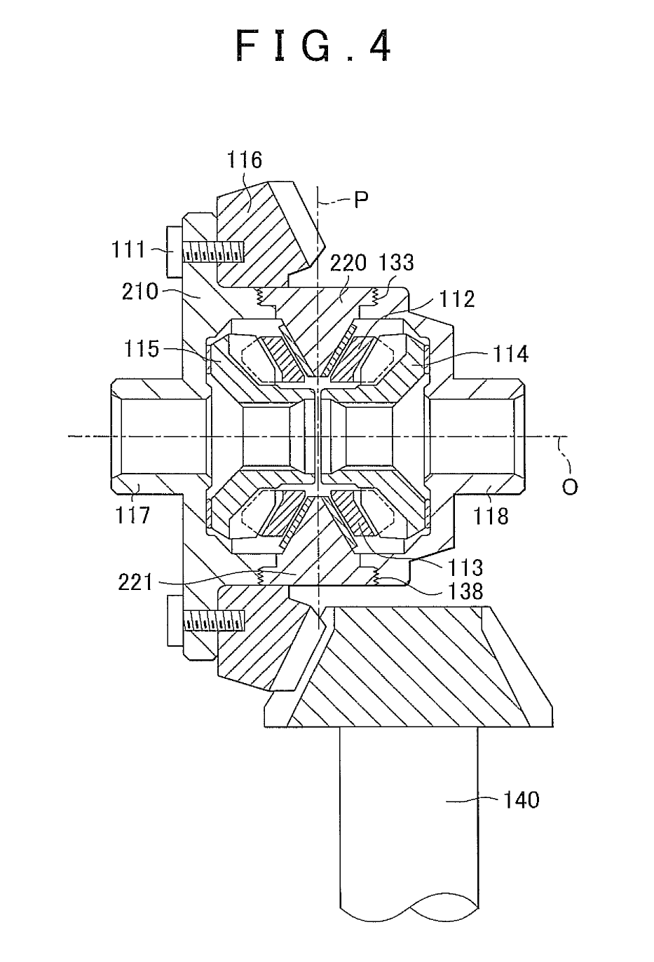

In an example shown in FIG. 4, a threaded portion 133 is formed on an peripheral surface of a fitting portion of a protruding portion 220, and a threaded portion 138 is formed on a peripheral surface of a fitting portion of a protruding portion 221. Thus, the protruding portions 220 and 221 are screwed into a differential case 210. Therefore, it is possible to easily adjust the positions of the protruding portions 220 and 221 in the direction of the rotation center line P. Accordingly, it is possible to adjust the amount of engagement between the pinion gears 112 and 113 and the side gears 114 and 115.

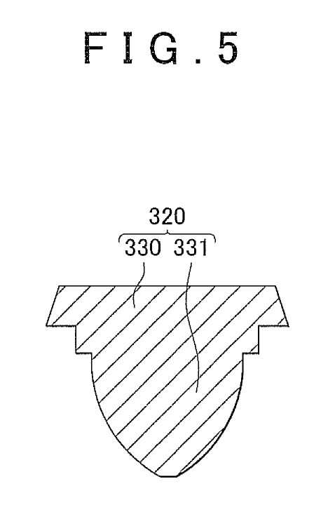

As shown in FIG. 5, an outer peripheral surface of a tapered protrusion 331 may be curved. By forming the outer peripheral surface of the tapered protrusion 331 in this manner, the pinion gear 112 is in line contact with the protruding portion 320. Therefore, it is possible to reduce the possibility that the pinion gear 112 and the protruding portion 320 wear. Each of the protruding portions 120, 121, 220, 221, and 320 may be a columnar pin.

Thus, the embodiment of the invention that has been disclosed in the specification is to be considered in all respects as illustrative and not restrictive. The technical scope of the invention is defined by claims, and all changes which come within the meaning and range of equivalency of the claims are therefore intended to be embraced therein. Further, the above-described numerical values and the like are illustrative, and the invention is not limited to the above-described numerical values and ranges.

What is claimed is:

1. A differential gear device comprising:
a case in which a housing portion is formed, and which rotates around a rotation center line;
a first protruding portion that is located at a position away from the rotation center line, and protrudes from an inner surface of the case toward the rotation center line;
a first gear that is provided around the first protruding portion, and that is rotatable;
a second gear including a first base portion that has a ring shape, and a first connection portion that is formed on an inner peripheral surface of the first base portion, and that is connected to a first output shaft, wherein the second gear engages with the first gear; and
a third gear including a second base portion that has a ring shape, and a second connection portion that is formed on an inner peripheral surface of the second base portion, and that is connected to a second output shaft, wherein the third gear engages with the first gear,
wherein one end of the first base portion, which is located in the case at a position more inward than an opposite end of the first base portion in a direction of an axis of the first output shaft, is located in a region that is located directly ahead of the first protruding portion in a direction in which the first protruding portion protrudes.

2. The differential gear device according to claim 1, wherein
one end of the first connection portion, which is located in the case at a position more outward than an opposite end of the first connection portion in the direction of the axis of the first output shaft, is located more inward than the opposite end of the first base portion, in the direction of the axis of the first output shaft.

3. The differential gear device according to claim 2 further comprising:
a cooling medium supply portion through which a cooling medium is supplied into the case,
wherein the first base portion includes a first increasing-diameter portion located closer to the inner surface of the case than the first connection portion is;
a diameter of an inner peripheral surface of the first increasing-diameter portion increases in a direction from the first connection portion toward the inner surface of the case; and
a first cooling medium receiving portion that receives the cooling medium is formed by the inner peripheral surface of the first increasing-diameter portion, an outer peripheral surface of the first output shaft, and the inner surface of the case.

4. The differential gear device according to claim 3, wherein
a thickness of the first increasing-diameter portion in a direction perpendicular to a hypothetical center plane positioned at a center between the inner peripheral surface of the first increasing-diameter portion and an outer peripheral surface of the first increasing-diameter portion is constant from one end of the first increasing-diameter portion, which is located closer to the first connection portion than an opposite end of the first increasing-diameter portion is, to the opposite end of the first increasing-diameter portion, which is located closer to the inner surface of the case than the one end of the first increasing-diameter portion is.

5. The differential gear device according to claim 2, wherein
one end of the second connection portion, which is located in the case at a position more outward than an opposite end of the second connection portion in a direction of an axis of the second output shaft, is located more inward than one end of the second base portion in the direction of the axis of the second output shaft, the one end of the second base portion being located in the case at a position more outward than an opposite end of the second base portion in the direction of the axis of the second output shaft.

6. The differential gear device according to claim 5, further comprising
a cooling medium supply portion through which a cooling medium is supplied into the case,
wherein the second base portion includes a second increasing-diameter portion located closer to the inner surface of the case than the second connection portion is;
a diameter of an inner peripheral surface of the second increasing-diameter portion increases in a direction from the second connection portion toward the inner surface of the case; and
a second cooling medium receiving portion that receives the cooling medium is formed by the inner peripheral surface of the second increasing-diameter portion, an outer peripheral surface of the second output shaft, and the inner surface of the case.

7. The differential gear device according to claim 6, wherein
a thickness of the second increasing-diameter portion in a direction perpendicular to a hypothetical center plane positioned at a center between the inner peripheral surface of the second increasing-diameter portion and an outer peripheral surface of the second increasing-diameter portion is constant from one end of the second increasing-diameter portion, which is located closer to the second connection portion than an opposite end of the second increasing-diameter portion is, to the opposite end of the second increasing-diameter portion, which is located closer to the inner surface of the case than the one end of the second increasing-diameter portion is.

8. The differential gear device according to claim 1, wherein
one end of the second base portion, which is located in the case at a position more inward than an opposite end of the second base portion in a direction of an axis of the second output shaft, is located in a region that is in a shadow of the second protruding portion when light is emitted from the outside of the case to the second protruding portion in a direction in which the second protruding portion protrudes.

9. The differential gear device according to claim 8 wherein
the second protruding portion protrudes in a direction perpendicular to the rotation center line.

10. The differential gear device according to claim 1 wherein
the case includes a first shaft support portion that supports the first output shaft; and
at least a portion of the first shaft support portion projects from the inner surface of the case toward the first increasing-diameter portion.

11. The differential gear device according to claim 10 wherein
the case includes a second shaft support portion that supports the second output shaft; and
at least a portion of the second shaft support portion projects from the inner surface of the case toward the second increasing-diameter portion.

12. The differential gear device according to claim 1, wherein
the first protruding portion protrudes in a direction perpendicular to the rotation center line.

13. The differential gear device according to claim 1, wherein
the first gear is provided around a peripheral surface of the first protruding portion.

14. The differential gear device according to claim 1, wherein
the first gear includes a third base portion that has a ring shape by having a through hole, and teeth formed on an outer peripheral surface of the third base portion; and
the first protruding portion is inserted in the through hole.

15. The differential gear device according to claim 1, wherein
the second gear and the third gear rotate around the rotation center line.

16. The differential gear device according to claim 1, wherein
one end of the first base portion is located in a region that is in a shadow of the first protruding portion when light is emitted from an outside of the case to the first protruding portion in a direction in which the first protruding portion protrudes.
